(19) United States
(12) Patent Application Publication
(10) Pub. No.: US 2014/0354939 A1
(43) Pub. Date: Dec. 4, 2014

(54) Eyewear Retaining Device with Resealable Container

(71) Applicant: Steven Joseph Walicki, Mequon, WI (US)

(72) Inventor: Steven Joseph Walicki, Mequon, WI (US)

(21) Appl. No.: 13/907,859

(22) Filed: Jun. 1, 2013

(51) Int. Cl. G02C 3/00

(52) U.S. Cl. CPC G02C 3/003; G02C 3/00
USPC 351/43; 351/155; 351/157; 29/428

(57) ABSTRACT

The nature of the invention relates to eyewear retaining devices. In the past, many eyewear retainers have been produced; however, none have combined an attached resealable container with an eyewear retainer. The invention provides the user with a new location to store personal affects. Personal items such as ID cards, credit cards, sunscreen and electronic devices, etc. . . . can now be worn on the user's head and around the user's neck while attached to the user's eyewear. The invention also combines the advantages of floating wallet and floating eyewear retainers. The invention allows the user to keep his or her eyewear and personal items inside the invention from sinking. Several variations of the invention exist such that the present invention can be waterproof, have a translucent viewing window and/or be connected to itself to form a band that con be affixed to the user's body without the use of eyewear.

### CLAIM OF PRIORITY

This application claims priority from;

### U.S. Provisional Application No. 61/654,850.

### CROSS-REFERENCE TO RELATED APPLICATIONS

References Cited [Referenced By]
U.S. patent Documents

| | | |
|---|---|---|
| U.S. Pat. No. 1,819,738 | August 1931 | Daniels |
| U.S. Pat. No. 2,704,961 | March 1955 | Well |
| U.S. Pat. No. 3,450,467 | June 1969 | Phillips |
| U.S. Pat. No. 4,133,604 | January 1979 | Fuller |
| U.S. Pat. No. 5,092,668 | March 1992 | Welch |
| U.S. Pat. No. 5,575,042 | November 1996 | Kalbach |
| U.S. Pat. No. 5,664,291 | September 1997 | Stoller |
| U.S. Pat. No. 6,053,612 | April 2000 | Macintosh |
| U.S. Pat. No. 6,644,808 | November 2003 | Liu |
| U.S. Pat. No. 6,941,619 | September 2005 | MacKay |
| U.S. Pat. No. 7,284,855 | October 2007 | Bent |
| U.S. Pat. No. 7,467,867 | December 2008 | Williams |
| D607919 | January 2010 | Williams |
| U.S. Pat. No. 8,092,009 | January 2012 | Williams |
| 2007/0046889 | March 2007 | Miller et al. |
| U.S. Pat. No. 6,478,145 | November 2002 | Mitchell |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

For many decades, eyewear users have attached strings, cloth-based retainers, lightweight chains, and small ropes to eyeglasses to loosely retain them upon a wearer's upper torso when not positioned upon the wearer's head. Several decades ago, “Croakies®” were introduced and they are essentially neoprene retainer straps having a tubular portion for receiving eyeglass temples and a rear flat portion that extends around the rear of a user's head. Croakies® immediately became popular with skiers, fisherman, and hunters who are active and desire a means to retain eyewear (whether corrective or tinted lenses) while engaged in activities that might result in the loss or damage of the eyewear. In response, a wide variety of colors and patterns have been introduced for Croakies® and other retainers known in the industry.

In many instances where a user is wearing an eyewear retainer, they need a place to store personal items. For instance, at the beach, when the user is wearing only a swimming suit and eyewear, the user has no place to store personal belongings such as a credit card, ID card, cell phone or sunscreen. The increasing rate of theft in today's society leaves the user no choice but to carry his or her belongings at all times. In such a situation where a user has no pockets, a user may be required to carry his or her wallet in hand along with a cell phone or other personal belongings. Also, with the increased rate of skin cancer, the need has arisen for people to wear sunscreen to protect them from the damaging UV light from the sun. There is a need to have a convenient place to carry items such as sunscreen and other personal items when the user is outside.

Unfortunately, Croakies® and other types of eyewear-retaining devices have not addressed this particular personal-storage problem. Eyewear retainers today have not made full use of the available space behind the wearer's head. Likewise, wallets today are only designed to be placed in a pocket and not attached or attachable to ones eyewear. The combination of these products has not yet been developed and serves as a valuable and novel improvement over the prior art.

Hence, what is needed is an eyewear-retaining device which also embodies a resealable container to store personal items.

In the prior art, various retainers for eyeglasses have been advanced which hold eyewear through the use of a band around the head. These devices have worked well in many instances, but eyewear retainers that embody a resealable container to store one's belongings while still comfortably holding the eye-glasses in position are still desired.

U.S. Pat. No. 2,481,946 illustrates a neck retainer for spectacles that has a small tubular member attached to a fabric strap that fits around the neck and holds the glasses in position when the eye-glasses are actually off. In other words, the strap is to hold the glasses in place around a person's neck rather than retain the glasses in position during use. Moreover, the prior device does not embodying a resealable container as provided for in the present invention.

A similar device is shown in U.S. Pat. No. 2,704,961 where a neck strap is utilized for retaining the eye-glasses in position when the glasses are removed from the face and are supported around the neck. Again, the prior device does not retain eyewear while in use or comprise a resealable container as provided for in the present invention.

U.S. Pat. No. 3,450,467 illustrates a spectacle retainer that grips the spectacles, and attaches to the temple pieces or bows of the spectacles to hold the spectacles in position. A type of neck strap for supporting eye-glasses when removed is shown in U.S. Pat. No. 3,879,804 which illustrates a band that clips onto spectacles or goggles and will grip these spectacles or goggles through a tightening loop connection. A similar type device is shown in U.S. Pat. No. 3,874,776. Likewise, U.S. Pat. No. 3,502,396 illustrates a nonstretch adjustable eyeglass holder that fits behind the head during use and has a series of holes for a fastener that provide for adjustment of the length of the strap after the strap has been attached to the bows or temple pieces of the eye-glasses. While each of these prior devices is designed to retain the user's eyewear when the eyeglasses are being worn, none combines this feature with a resealable storage container.

Finally, U.S. Pat. No. 6,478,145, illustrates an eyeglasses retainer and case with detachable straps. In this invention the straps are used to store the eyewear after they are removed from the users head. The case is strictly for use with storing eyewear once the wearer has removed the eyewear from their head. Accordingly, this prior device cannot store personal belongings other than a user's eyewear and is unable to store any items while the user's eyewear is in use. Moreover, this prior retainer does not include a resealable container.

Accordingly, none of the known prior eyeglass-retaining devices combines the benefits of an eyewear retainer with a waterproof resealable storage container for storage of a user's various personal belongings.

### BRIEF SUMMARY OF THE INVENTION

The field of endeavour to which the present invention pertains is personal storage and eyewear retainers. While there are many eyewear retainers on the market, often referred to generically as “Croakies®,” there are no eyewear retainers that can store items therein while the user is wearing his or her eyewear. Users neither want to lose their eyewear nor the personal items that they would typically store in a wallet or bag. Therefore, the need exists to combine an eyewear retainer and a storage container so the user has only one storage container to carry instead of several (e.g., a wallet, cell phone, bag and eyewear). The resealable container can be any size but, preferably, the storage container is large enough to hold credit cards and able to stretch to fit an iPhone® or other cell phone. The rescalable opening is preferably positioned on one side of the container (e.g., the side or top). However, as will be appreciated by those in the art, multiple openings may be utilized in the storage container. The eyewear retention device with resealable container is placed around the head behind the ears, thereby holding the glasses in position under a slight tension. The device is not primarily designed as a neck strap for supporting the eyewear when removed from the eyes, although it may be used as such if desired. The eyewear also can be pushed up to the forehead and held in position with the band remaining around the wearers head behind the ears. The device is intended for use at any time desired, but generally, the user will be engaged in physical activities, such as sports or outdoor activities, when the eyewear retention device with resealable container is used.

With the use of a buoyant material such as neoprene, or other well-suited similar material, the invention also embodies a floating aspect. If the user loses his or her eyewear in any body of water the user may retrieve the eyewear, the invention, and the contents inside of the invention with ease. The user can also walk into the water while keeping his or her valuables dry and safe. With the use of a waterproof material and a waterproof seal, the contents inside the container will remain dry and ensure that sensitive items such as electronic devices and money will not be adversely affected. With the option of having a translucent window in the container, it is possible for the user to display fishing licenses and other items while wearing the invention as well as operating their electronic device's touch screens through the window. The addition of electronic devices such as speakers embedded in to the retaining strap, or stored in the resealable container adds a safety element. Now users can listen to music with out the use of ear phones which block out other sounds such as vehicle horns. Other electronic devices such as GPS units, batteries, solar panels, mp3 players, cellular phones, radios and other electronic devices may be incorporated in to the eyewear retention device with resealable container, whether comprised in the retaining strap or in the container itself. With the addition of a connecting device such as hook and loop on the far right and far left ends of the retaining strap, the invention may connect to itself forming a band with out the use of eyewear. This feature allows the user to store the eyewear retention device with resealable container around their arm, leg or any thing they would like to wrap the device around. Another advantage of the present invention is that it can hold ice cubes, ice packs or heat packs that help to cool or heat a user's neck. In most outdoor activities people use eyewear to protect their eyes from the sun; by attaching a resealable container to the eyewear retention device, users can now utilize the space behind the head to carry their valuables such as sunscreen, tobacco, cash, keys, credit cards, prophylactics, electronics, licenses and any other item or items that can fit inside the container.

The invention may be summarized as an eyewear retention device with attached resealable container for head-worn eyewear. Notably, the invention can be employed with eyewear that lacks temples by directly connecting the invention to the frame. It will be appreciated by one of skill in the art that eyewear includes, but is not limited to, items such as sunglasses, sight correcting eyeglasses, safety glasses and goggles.

It will also be appreciated by one of skill in the art that the resealable container may be devised through the use of various sealing mechanisms including, but not limited to, zippers, buttons, hook and loop, dual lock, zip lock, fold and buckle, clasp, bungee cord, adhesive or any other well suited means of closing a container.

It will also be appreciated by one of skill in the art that the eyewear retention device with resealable container may be created from the use of various materials including, but not limited to, synthetic polymers, synthetic fabrics, natural fibers, leather, rubber, neoprene, plastics, metals, etc. The use of one or a combination of many materials may be used to manufacture the invention.

Typically, a retaining strap is devised by connecting two temple connectors to each other, thus forming a strap, string or band that is worn behind the user's head while connected to eyewear. The said retaining strap holds the eyewear on the user's head while in use as well as around the user's neck while not in use.

The Eyewear Retainer with Resealable Container is an improvement upon the already existing eyewear retainer. The invention can be made of any material that can retain a pair of eye glasses to the user. Neoprene, cotton, nylon, etc can be used to connect the eyewear to the user while encompassing a container. Velcro, zippers or any other well-suited sealing device is used to hold the container closed.

In order to manufacture the invention, the following steps can be followed but are not limited to. First, the desired material is cut out to form the overall shape of the retaining strap. Second, the right and left ends of the retaining strap need to be sewn in to a 2 inch long eyewear connect tube with an inside diameter measuring ⅛ of an inch. Third, the pocket is cut out of the desired material so that it will fit over the middle third of the retaining strap to form a pocket. This pocket can be variable sizes but the ideal size is slightly larger than a credit card or drivers license, approximately 4.5×3.0 inches Forth, the Velcro is sewn on to the retaining strap and to the pocket cut out in step three to form the flap opening or resealable opening. Fifth the pocket is sewn to the retaining strap on three sides leaving the Velcro mated areas unsewn for opening of the container. The invention now can be connected to a pair of eyewear and items can be placed inside of the closable pocket.

The specific claim of the inventor as regards to his invention is an eyewear retaining strap that also embodies a closable container. The container will allow the user to carry items such as credit cards, driver's licenses, keys, cash or whatever the user would like on the back of their head, around the neck or on the back while wearing their eyewear. The invention can also utilize an adjustable strap to tighten the pocket to the back of their head or let it lay loose on the user's neck or back. It can also utilize a waterproof container so that the contents stay dry; the invention can also utilize Velcro to wrap the retaining strap around an arm, leg or any other thing the user wants to secure the container around.

### BRIEF DESCRIPTION OF THE DRAWINGS

An eyewear retention device incorporating a resealable container is depicted in the attached drawings, which form a portion of the disclosure, and wherein:

FIG. 1 is a perspective view of the preferred embodiment of the invention 14; this view shows the invention 14 placed upon the end portions of the temples 9 of a typical pair of eyewear 8 showing the general placement of the temples 9 inserted within the temple connectors 5, 6. The retaining strap 2 is shown connecting the temple connectors 5, 6 with the resealable container 1 behind the strap 2 and in between the temple connectors 5, 6 in a central location. The rescalable opening 3 is shown on the left side of the resealable container 1. The sealing mechanism 4 is shown on the left side of the resealable container 1 depicted by the area inside the dashed lines. The sealing mechanism 4 is attached in between the retaining strap 2 and the resealable container 1. The eyewear 8 shows lenses 10 in a typical form of eyewear.

FIG. 2 is a front elevation drawing of the preferred embodiment of the invention. From this view the retaining strap 2 is shown with the right temple connector 5 and the left temple connector 6. The resealable opening 3 is shown on the left of the container or pouch. The sealing mechanism 4 is shown on the inside of the dashed lines and is located in between the strap 2 and resealable container 1. The resealable container 1 is attached to the back of this view and therefore not viewable.

FIG. 3 is a rear elevation drawing of the preferred embodiment of the invention. The view depicts the invention as it would be seen from the lenses 10 perspective with the right temple connector 5 on the far left of the figure and left temple connector 6 on the far right of the figure. The resealable container 1 is centrally located in the view while the resealable opening 3 is on the right side of the resealable container 1. The sealing device 4 is within the dashed lines on the right side of the resealable container 1. The retaining strap 2 is shown on the right and left sides of the resealable container 1; the retaining strap continues behind the resealable container 1. The tube junction line 7 is shown on both the right temple connector 5 and the left temple connector 6, in the preferred embodiment this is where the material joins together to form a tube or temple connector 5, 6.

FIG. 4 is a top elevation drawing of the preferred embodiment of the invention showing the eyewear retaining strap 2 connecting the two temple connectors 5, 6. The resealable container 1 is shown attached to the retaining strap 2 in a centrally located position. The resealable opening 3 is shown on the right side of the resealable container 1. The sealing mechanism 4 is shown on the right side of the resealable container 1 and on the mated area of the retaining strap 2, the sealing device 4 forms the resealable opening 3.

FIG. 5 is a right side elevation drawing of the preferred embodiment of the invention. From this view the right temple connector 5 is viewable. The retaining strap 2 is on the left side of the figure. The resealable container 1 is on the right side of the figure. From this view the resealable opening 3 is not viewable, this is the sealed or sewn side of the resealable container 1 and/or pouch. The tube junction line 7 is depicted on the right side of temple connector 5.

FIG. 6 is a left side elevation drawing of the preferred embodiment of the invention. From this view the resealable opening 3 is shown in between the retaining strap 2 and the resealable container 1, the left temple connector 6 is shown. The tube junction line 7 is depicted on the left side of temple connector 6.

FIG. 7 is a front elevation drawing similar to that depicted in FIG. 2. This figure shows an embodiment of the present invention with a translucent viewing window 11 suitable for displaying items or documents inside of the pouch or container.

FIG. 8 is a front elevation drawing similar to that depicted in FIG. 2. This figure shows an embodiment of the present invention with hook 12 and loop 13 on the temple connectors 5, 6. The right side of the figure shows the hook side 12 on the front of temple connector 5. On the left side of the view the loop side 13 is behind temple connector 6. The hook 12 and loop 13 can be attached to each other forming a loop or band in order to attach the device to itself around an arm, leg or anything else that the user would like to attach the invention to without the use of eyewear. The use of any other well-suited connecting device may be used, such as but not limited to, buttons, straps, clasps, dual lock, and snaps.

### DETAILED DESCRIPTION OF THE PREFERRED EMBODIMENT

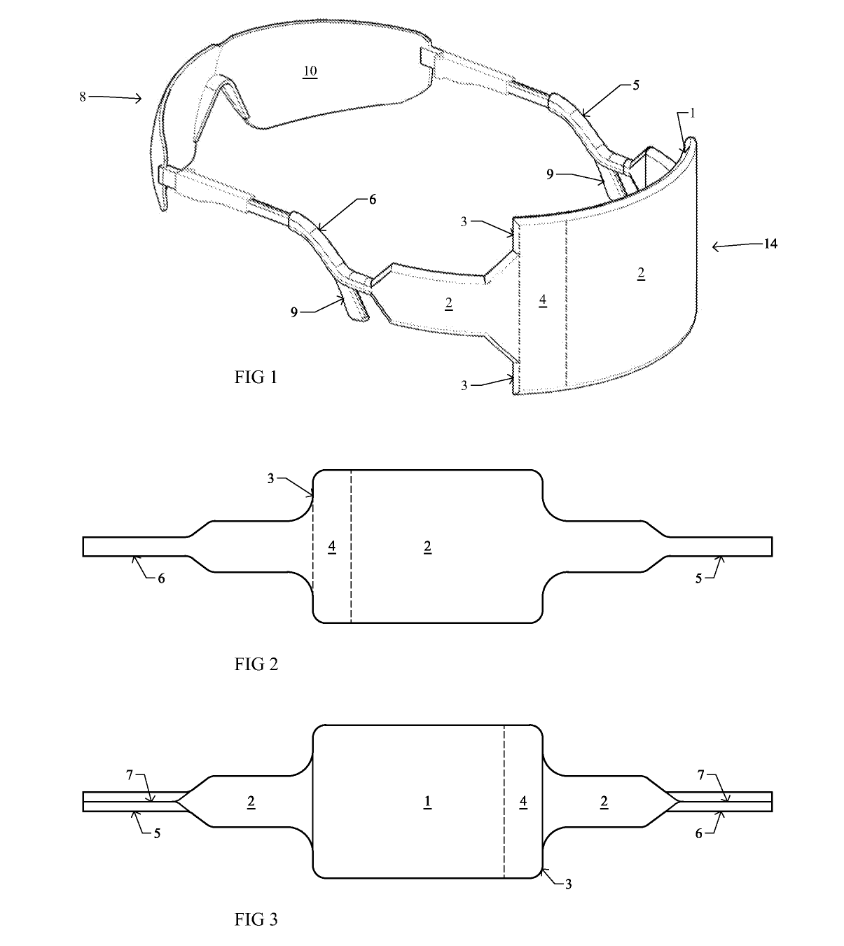

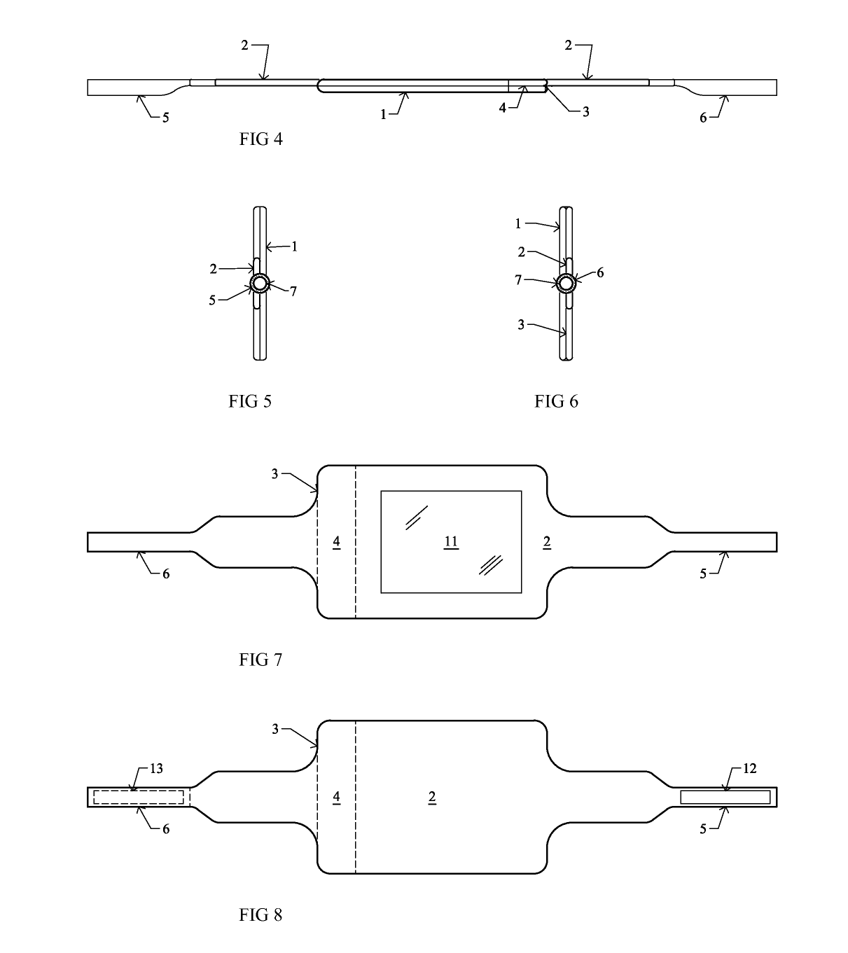

Referring to FIG. 1, a pair of eyewear illustrated generally at 8 as shown has lenses 10, and temples or bow pieces indicated generally at 9 and hingedly attached to the lenses 10 of the eyewear in the normal manner. Eyewear 8 has temple connectors 5, 6 slipped on the temples 9 as shown in FIG. 1. The preferred embodiment 14 of the eyewear retaining device with resealable container is comprised of said temple connectors 5, 6, retaining strap 2, resealable container 1 (located behind retaining strap 2), sealing device 4, and any well suited joining mechanism or thread sewn to connect materials throughout the invention.

The retaining strap 2 comprises a flat strap member 2, a first temple connector 5, and a second temple connector 6 at the opposite ends of the strap. The first and second temple connectors 5, 6 are formed by folding or rolling the strap into a tubular form and then affixing the edges of the flat band together along the junction line 7 as shown generally in FIG. 3. The edges can be fused, glued, or sewn together or the band can be molded initially with temple connectors at its ends. The temple connectors 5, 6 are open at both ends so they slip onto the straight portions of the temples 9 and the ear pieces extend out as shown.

In the preferred form, the retaining strap 2 and resealable container 1 are made of resilient or elastic material such as closed cell neoprene foam sandwiched with a fabric layer such as Nylon Tricot. It will be appreciated that neoprene, cotton, nylon, plastics, polymers, natural fibers, synthetic fibers, rubber or any other well-suited material can be used. Preferably, the invention will include some well-suited resilient material to connect the eyewear 8 to the user while encompassing a resealable container 1.

The closed cell foam can be of any desired thickness and, as known, closed cell foam floats so that if eyewear 8 is dropped in water while connected to the eyewear retention device of the present invention, the preferred embodiment will tend to support the eyewear 8 and the contents of the preferred embodiment 14 in the water.

The eyewear retention device with resealable container is utilized by slipping the temple connectors 5, 6 over the eyewear temples 9, and adjusting the temple connectors 5, 6 so that the resealable container 1 and retaining strap 2 are under sufficient tension around the back of a user's head to hold the eyewear 8 under light tension rearwardly on the nose and adjacent to the eyes during use.

It should be noted that, in adjustment, the temple connectors 5, 6 may be slid along the temples or bow pieces 9 because of the fabric layer and, as tension is exerted from the strap 2, which tends to pull on the temple connectors 5, 6, the fabric covering the temples 9, and against which the neoprene foam is mounted, will tend to elongate and tighten down onto the temples 9 much in the manner of the so-called woven Chinese finger traps. However, adjustment can easily be effected by placing the temple connectors 5, 6 under compression or pushing them off or on as desired. However, tension does tend to be resisted by tightening the fabric portions down onto the temples 9 and by friction. Note in FIG. 1 that temple connectors 5, 6 are moveable along the temples 9 to adjust the tension of the preferred embodiment 14 of the invention.

In order to utilize the resealable opening 3 of the preferred embodiment 14, the user may take the eyewear 8 off of his or her head while still connected to the preferred embodiment 14 of the invention and open the resealable opening 3 by separating the sealing mechanism 4. The user may also open the resealable opening 3 while the device is on their head, or around their neck, by reaching behind their head and opening the sealing mechanism 4. Once the resealable opening 3 is open, the user may place items inside of the resealable container 1 and reseal or close the resealable opening 3 by sealing the sealing mechanism 4. Once the user's items are in the resealable container 1 the eyewear retention device with resealable container can be worn on the user while the user's eyewear 8 is on his or her head, forehead or around his or her neck. The eyewear retention device with resealable container may be removed from the eyewear 8 and the user may continue to use the invention to store belongings in his or her pocket or anywhere else that the user would like to store the invention. Shown in FIG. 8, the invention can also utilize a hook 12 and loop 13 mechanism to wrap the retaining strap 2 around an arm, leg or any other thing around which the user wants to secure the invention. Any other well-suited connecting device may be used to attach the invention to itself by attaching the right side of the retaining strap to the left side of the retaining strap forming a loop without the eyewear being utilized. This adds to the usefulness of the invention by permitting mounting of the invention in numerous locations.

Displayed in FIG. 7 is a variation of the invention wherein a translucent window 11 is housed within the retaining strap 2. This variation allows the user to display documents or other items stored within the container or pouch such as fishing, hunting and driver's licenses etc. The translucent window 11 can be manufactured from a material suitable for operating touch screens on electronic devices such that the user can operate such electronic devices without opening the container or pouch.

Although not displayed in the preferred embodiment the invention can also utilize a waterproof container so that the contents stay dry and protected—any well suited waterproof material may be used. In this embodiment, a waterproof sealing device 4 is preferably used (such as a waterproof zipper or rolled dry bag apparatus or any other well suited waterproof sealing device) such that the invention is entirely protected from water or other liquids.

In order to manufacture the preferred embodiment of the invention, the following steps can be followed but, as will be appreciated by those skilled in the art, the invention is not so limited. First, the desired material may be die cut or cut out to form the overall shape of the retaining strap 2. Second, the right temple connector 5 and left temple connector 6 of the retaining strap 2 may be sewn, joined, fused or otherwise connected to form the tube at junction line 7. Preferably, temple connector tubes 5 and 6 are approximately 2-inches long with an inside diameter measuring approximately ⅛ of an inch. As will be appreciated, varying lengths and diameters may be better suited for different shapes of eyewear. Third, the resealable container 1 is cut out of the desired material in a rectangular shape so that it will attachably fit over the middle third of the retaining strap 2, to form a pouch or container. This pouch or container can vary in size but the preferred size is slightly larger than a credit card or driver's license, approximately 4.5 inches long by 3.0 inches in height. Forth, the sealing device 4 is sewn on to the retaining strap 2 as shown FIG. 2 on the left side of the container or pouch. The sealing device 4 is then sewn or attached onto the resealable container 1 cut out in step three, so that the sealing device 4, on both the strap 2 and the resealable container 1, mate with each other when the strap 2, and resealable container 1, are sewn or otherwise attached to each other. The mated components of sealing device 4, form the resealable opening 3. Fifth, the resealable container 1 is sewn to the retaining strap 2 on three sides leaving the mated areas of the sealing device 4 unsewn (or otherwise permanently connected) for opening and closing of the container or pouch. The invention as assembled may then be connected to a pair of eyewear 8 and items can be placed inside of the container or pouch formed by the retaining strap 2 and resealable container 1.

It will be appreciated that the invention can be sewn on two sides, top and bottom with the sealing device 4 already attached to the retaining strap 2 and resealable container 1. The device can be turned inside out in order to hide the stitching. The right temple connector 5 is then pulled through the pouch or container. Once the temple connector 5 is pulled through the container 1 the opening shall be sealed by sewing or any other well-suited sealing method. This will close the third sealed side of the container 1 leaving the opposite side of the pouch resealable by the sealing device used.

It will be appreciated that in automatically forming the temple connectors 5 and 6 they can be formed quickly, and may even be molded into position on the ends of the band.

The eyewear 8 can be placed comfortably and securely on the forehead when not in use by merely permitting the retaining strap 2 to stretch as the eyewear 8 is raised. The ear pieces or temples 9 of the eyewear 8 go through the temple connectors 5, 6 as shown in FIG. 1 such that they protrude out and fit over the ears of the user.

By sliding the temple connectors 5, 6 along the temple pieces 9, the foam material additionally provides a cushion between the head and the temples 9 for greater comfort.

No mechanical fasteners are necessary, as shown, and the quick, easy installation of the temple connectors 5, 6 formed from a unitary band of elastic, foam-type material provides for easy adjustment, low cost and attractive usage. However, any well-suited connecting mechanism may be used to attach the retaining strap 2, to a user's eyewear 8.

The eyewear retaining device with resealable container allows the user to carry items (such as credit cards, driver's licenses, keys, cash, sunscreen or whatever the user desires) on the back of his or her head, around the neck or on the back while wearing eyewear 8. The invention can also be used without eyewear to store personal items. The invention can also utilize an adjustable strap to tighten the invention to the back of a user's head or allow it to rest loosely on the user's neck or back. It can also utilize a waterproof container so that the contents stay dry; the invention can also utilize hook and loop or any other well suited connecting device to wrap the retaining strap around an arm, leg or any other object around which the user wants to secure the invention.

In the foregoing description, certain terms have been used for brevity, clarity and readability. No unnecessary limitations are to be implied there from beyond those required by the prior art because such terms are used for descriptive purposes only and are intended to be broadly construed.

Moreover, the description and illustration of the invention is an example and the invention is not limited to the exact details shown or described. While certain exemplary preferred embodiments have been described and illustrated in the accompanying drawings, it is to be understood that such embodiments are merely illustrative and not restrictive on the broad invention. Further, it is to be understood that this invention shall not be limited to the specific construction and arrangements shown and described since various modifications or changes may occur to those of ordinary skill in the art without departing from the spirit and scope of the invention as claimed.

Having set forth the nature of the invention, what is claimed is:

1. An eyewear retention device comprising a resealable container.

2. The device of claim 1, wherein said retention device comprising a container is made from neoprene, polypropylene, synthetic rubber, rubber, cotton, wool, silk, leather or other natural fiber, nylon, polyester, or other synthetic polymer or plastic.

3. The device of claim 1, wherein said container is removably coupled to said eyewear retainer.

4. The device of claim 1, wherein said container is connected to or created from said eyewear retention device.

5. The device of claim 1, wherein said eyewear retention device is removably coupled to eyewear.

6. The device of claim 1, wherein said container is resealable.

7. The device of claim 1, wherein said eyewear retention device comprising a container comprises electronic components such as speakers, gps units, solar panels, batteries, or other electronic devices.

8. The device of claim 1, wherein said eyewear retention device comprising a container is joinable to itself to form a band for use without eyewear.

9. The device of claim 1, wherein said eyewear retention device comprises two temple connectors, connected by a retaining strap, and a resealable container connected to the retaining strap, such that when the temple connectors are attached to eyewear and the eyewear is worn over the ears of the wearer, the retaining strap with the resealable container extends rearward from the head of the wearer.

10. The device of claim 1, wherein said retaining strap comprises two temple connectors.

11. The device of claim 1, wherein said container comprises a hook and loop, zipper, waterproof zipper, dual lock, snap, button, or adhesive resealing mechanism.

12. The device of claim 1, wherein said container is waterproof.

13. The device of claim 1, wherein said container has at least one opening.

14. The device of claim 1, wherein said eyewear retention device includes a transparent material to display items inside of said container.

15. The device of claim 1, wherein said container floats.

16. The device of claim 1, wherein said container can store personal items

17. The device of claim 1, wherein said eyewear retention device comprising a container can be comprised of a multitude of containers.

18. A device for retaining eyewear of the type having a left and right temple comprising;
A flat thin flexible band with an inner and outer facing surface adapted to attach at a first end to the left temple, circle behind a wearer's head, and attach at a second end to the right temple, the band having a wider central section and a pair of narrower end sections, the narrower end sections terminating at the first end and the second end;
The wider central section having a container attached to the inner surface and adapted to store personal items;
a closing mechanism cooperating with the container to partially seal said container.

19. The device of claim 19, wherein said container is waterproof

20. A method of producing an eyewear retention device comprising a container is made by following steps A through G;
(A) the desired material may be die cut or cut out to form the overall shape of the retaining strap;
(B) the right temple connector and left temple connector of the retaining strap may be sewn, joined, fused or otherwise connected to form temple connectors; as will be appreciated, varying lengths and diameters of the temple connectors may be better suited for different shapes of eyewear;
(C) the container is cut out of the desired material so that it will fit over the retaining strap, to form a pocket or container; this pocket or container can vary in size;
(D) the sealing device is attached on to the retaining strap;
(E) the sealing device is then sewn or attached onto the container cut out in step C, so that the sealing device, on both the retaining strap and the container, mate with each other when the retaining strap, and container, are sewn or otherwise attached to each other; the mated components of the sealing device form the resealable opening;
(F) the container is sewn or attached to the retaining strap on three sides leaving the mated areas of the sealing device unsewn (or otherwise permanently connected) for opening and closing of the container,
(G) the invention as assembled may then be connected to a pair of eyewear and items can be placed inside of the container or closable pocket.
